(19) United States
(12) Patent Application Publication
(10) Pub. No.: US 2008/0050940 A1
(43) Pub. Date: Feb. 28, 2008

(54) Electrical connector with moveably contact

(75) Inventors: Nan-Hong (Nick) Lin, Tu-Cheng (TW); Chia-Wei Fan, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/894,973

(22) Filed: Aug. 22, 2007

(30) Foreign Application Priority Data
Aug. 22, 2006 (CN) 200620075645.2

(51) Int. Cl. H01R 12/00

(52) U.S. Cl. 439/66

(57) ABSTRACT

Disclosed an electrical connector (500) comprises an insulative housing (510) having a body (511) with a mating interface (512) and a mounting surface (513) opposite to the mating interface. A plurality of passageways (514) extend from the mating interface toward the mounting surface and with a first wall (516) and a second wall (517) opposite to each other. A plurality of conductive contacts (520) moveably arranged in the corresponding passageways. Each contact includes a base (521) retained in the passageway, and a upper contacting portion (522) extends from one side of the base in a direction toward the mating interface and a lower contacting portion (523) extends from another side of the base. The first free end (527) of the upper contacting portion abuts against the first wall of the passageway to prevent the contact from falling out of the passageway.

### BACKGROUND OF THE INVENTION

1. Field of the Invention

The present invention relates to the art of electrical connectors, and more particularly to an connector for electrically interconnecting an electronic package such as an central processing unit (CPU) with a circuit substrate such as a printed circuit board (PCB).

2. Background of the Invention

Electrical connection between two terminals is generally facilitated by normal force exerted from one terminal to the other. However, since surface of the terminal could be contaminated by dust or oxidation, it is preferable to generate a wiping displacement between two terminals during mating. With the wiping displacement between the terminals, dust or oxidation on the terminal could be wiped out, thereby ensuring reliable electrical connection between two mated terminals.

U.S. Pat. No. 5,244,396 issued to Matsuoka on Sep. 13, 1993 discloses an arrangement for electrical connector in which contact 9 is obliquely arranged and which may provide a wiping displacement between contact 9 and element 4. However, Matsuoka's device is too complicated to implement.

In Matsuoka device, element 11 is insert molded within element 1, while contact 9 is moveably arranged within the element 11. The contact 9 includes a pair of arms 8 which can be deformed when the contact 9 is pushed downwardly by element 4. As stated above, the Matsuoka device is too complicated to be implemented in the socket connector for used with a CPU. (U.S. Pat. No. 6,083,022 discloses another oblique arrangement of the contacts in the connector housing.

U.S. Pat. No. 5,820,389 issued to Hashiguchi on Oct. 13, 1998, discloses an electrical connector to be used between a printed circuit board and a LSI (Large Scale Integration) circuit of the type which is disclosed in Japanese Utility Model Publication (B) No. 13191/1995 (hereinafter referred to as the '191 Publication). Since the '191 device can not provide enough wiping displacement between the contacting end and a corresponding conductive pad, Hashiguchi (the '389 patent) then provides an improvement on the arrangement of the contact such that a contact end thereof may perform an effective wiping displacement over a corresponding pad to ensure an effective electrical connection.

As shown in FIGS. 9A, 9B and 9C, the contact 20 is arranged in a passageway formed vertically in the housing 10. The contact 20 includes an extension 24 having a free end 24b. Theoretically, when contact end 23a is depressed by the element 200, contact end 24b will displace from its original position. It is understandable that Hashiguchi device is better than the '191 device as the extension 24 displace more than that of the '191 device. However, since the contact 20 is vertically arranged within the passageway, it is unlikely that the contact end 23a to perform a wiping displacement with respect to the corresponding element 200. Understandably, Hashiguchi solves only portion of the problem encountered by the '191.

On the other hand, even the extension 24 is arranged obliquely, the wiping displacement conducted by the contact end 24b is still not enough since before the contact end 24b is moved when the portion 23a is moved vertically down, there is a deformation incurred in portion 21a. Accordingly, Hashiguchi still leaves an opening for further improvement.

By the way, Hashiguchi does not meet the requirement since only the contact end 24b displaces a short distance over a conductive pad, while the contact end 23 does not displace when it is contacting with corresponding conductive pad.

U.S. Pat No. 6,447,304 issued to Korsunsky discloses a first electrical device similar to the above described, and includes a first substrate having at least a first conductive pad formed thereon. A second electrical device includes a second substrate having at least a second conductive pad formed thereon. An electrical device is arranged between first and second electrical devices for electrically connecting the first and second conductive pads of the first and second electrical devices. The electrical device includes a housing defining at least a passageway extending between first and second surfaces. At least an electrical contact is moveably installed within the passageway with contacting ends extend beyond the surfaces. However, Matsuoka's device is too complicated to implement.

Therefore, there is a heretofore unaddressed need in the industry to address the aforementioned deficiencies and inadequacies.

### SUMMARY OF THE INVENTION

In order to achieve the objects set forth, an electrical connector in accordance with the present invention, comprises an insulative housing having a base with a mating interface and a mounting surface opposite to the mating interface. A plurality of passageways extend from the mating interface toward the mounting surface and with a first wall and a second wall opposite to each other. A plurality of conductive contacts each moveably arranged in the corresponding passageways. Each contact includes a base retained in the passage, and a upper contacting portion extends from one side of the base in a direction toward the mating interface and a lower contacting portion extends from another side of the base. The free end of the upper contacting portion abuts against the first wall of the passageway to prevent the contact from falling out of the passageway.

According to one aspect of the present invention, the electrical connector includes a hard stop formed on the second wall of the passageway.

According to another aspect of the present invention, the electrical connector includes a base of the contact in contact with the second wall of the passageway.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is an isometric view of an electrical connector in accordance with a preferred embodiment of the present invention, together with one contact in the housing;

FIG. 2 is an exploded, isometric view of FIG. 1; and

FIG. 3 is a cross section view of an electrical connector in accordance with a preferred embodiment of the present invention.

### DETAILED DESCRIPTION OF ILLUSTRATIVE EMBODIMENT

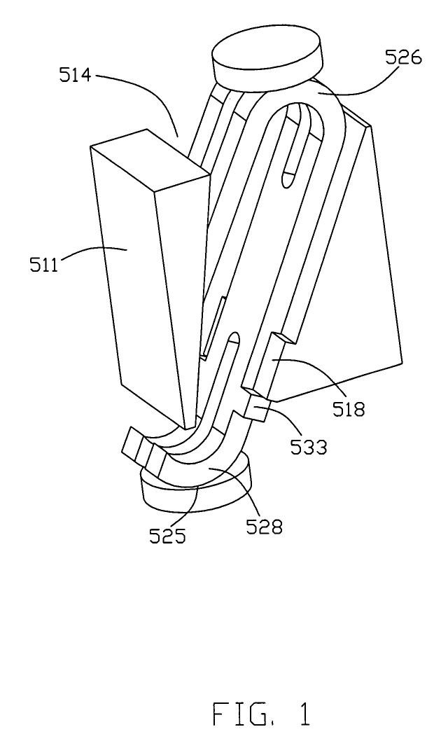

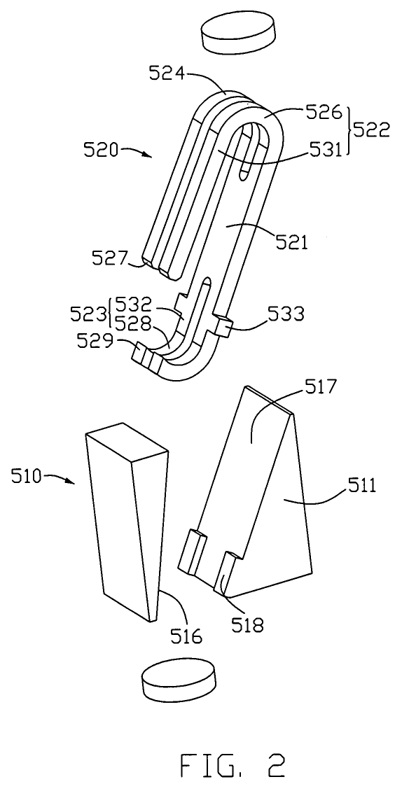

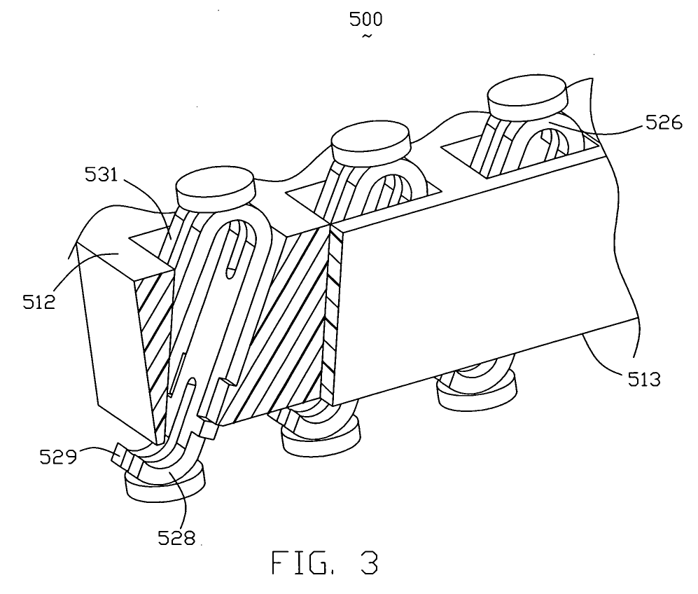

Referring to FIGS. 1 to 3, an electrical connector 500 in accordance with a preferred embodiment of the present invention includes an insulative housing 510 and a multiplicity of conductive contacts 520 received in the housing 510.

An insulative housing 510 having a body 511 with a mating interface 512 and a mounting surface 513 opposite to the mating interface 512. A plurality of passageways 514 extends from the mating interface 512 toward the mounting surface 513, with a first wall 516 and a second wall 517 opposite to the first wall 516. The first wall is offset with respect to the second wall. According to a preferred embodiment of the present invention, a hard stop 518 is formed on the second wall 517 of the passageway 514. On the other hand, other type of arrangement can be also applied, such defining an additional slot (not shown in figures) within the passageway so as to limit the movement of the contact within the passageway and which can also achieve the intended purpose such as the hard stop describe above.

A plurality of conductive contacts 520 are moveably arranged in the passageways 514, and each includes a base 521, a upper contacting portion 522 extending from one side of the base 521 in a direction toward the mating interface 512 and a lower contacting portion 523 extending from another side of the base 521. Each of the upper and lower contacting portion (522, 523) includes two contacting points (524, 525) formed by a pair of spring arms to be described below. A first angled portion 526 formed between the base 521 and the first free end 527 of the upper contacting portion 522; a second angled portion 528 formed between the base 521 and the second free end 529 of the lower contacting portion 523.

Each upper/lower contact portion (522, 523) includes a pair of spring arms (531,532) extending away from the base 521, and the spring arm 532 is provided with a tab 533 for abutting against the hard stop 518 of the housing 510 thereby limiting the contact from excessively moving upward, view from the drawings. According to a preferred embodiment of the present invention, the tab 533 is formed on the outer side of spring arms 532. Of course, the tab 533 can be formed on the other position as long as it can achieve to its intended purpose.

When the contacts 520 are assembled into the corresponding passageways 514 from the mounting surface 513, the base 521 is located within the passageways 514, with the first angled portion 526 extending beyond of the mating interface 512 and the second angled portion 528 extending also beyond of the mounting surface 513. At the same time, the first free end 527 of the upper contacting portion 522 will abut against the first wall 516 of the passageway 514 and the base 521 of the contact 520 is in contact with the second wall 517 of the passageway 514. With the first free end 527 abuts against the first wall 516, the contact 520 is also limited its movement downward as viewing from the drawing. Of course, the base 521 may extend from the mounting surface 513, with a tab 533 formed on the outer side thereof.

While the present invention has been described with reference to illustrative embodiments, the description of the invention is illustrative and is not to be construed as limiting the invention. Various of modifications to the present invention can be made to illustrative embodiments by those skilled in the art without departing from the true spirit and scope of the invention as defined by the appended claims.

What is claimed is:

1. An electrical connector comprising:
an insulative housing having a body with a mating interface and a mounting surface opposite to the mating interface,
a plurality of passageways extending from the mating interface toward the mounting surface, with a first wall and a second wall opposite to the first wall;
a plurality of conductive contacts moveably arranged in the passageways, each including a base, an upper contacting portion extending from one side of the base in a direction toward the mating interface and a lower contacting portion extending from another side of the base; and
wherein the free end of the upper contacting portion abut against the first wall of the passageway.

2. The electrical connector as recited in claim 1, wherein a hard stop formed on the second wall of the passageway.

3. The electrical connector as recited in claim 1, wherein said base of the contact is in contact with the second wall of the passageway.

4. The electrical connector as recited in claim 1, wherein the first wall is offset with respect to the second wall.

5. The electrical connector as recited in claim 1, wherein said contacts are assembled into the passageways from the mounting surface.

6. The electrical connector as recited in claim 1, wherein a first angled portion formed between the base and the free end of the upper contacting portion.

7. The electrical connector as recited in claim 5, wherein a second angled portion formed between the base and the free end of the lower contacting portion.

8. The electrical connector as recited in claim 1, wherein each of the upper and lower contacting portion includes two contacting points.

9. The electrical connector as recited in claim 6, wherein the first angled portion extend from the base located within the passageway and beyond the mating interface.

10. The electrical connector as recited in claim 8, wherein the second angled portion extend from the base located within the passageway and beyond of-the mounting surface.

11. The electrical connector as recited in claim 7, wherein each upper/lower contact portion include a pair of spring arms, and each spring arm is provided with a tab for abutting against the hard stop of the housing.

12. The electrical connector as recited in claim 1, wherein at least one tab formed on the contact.

13. The electrical connector as recited in claim 10, wherein at least one tab formed on the outer side of the pair of spring arms.

14. The electrical connector as recited in claim 1, wherein said base extends from the mounting surface, with a tab formed on the outer side thereof.

15. An electrical connector comprising:
an insulative housing defining at least one oblique passageway;
said oblique passageway defining an upward oblique wall and a downward oblique wall under a condition that the downward oblique wall is steeper than the upward oblique wall; and
a contact being disposed in the passageway and defining a primary section clinging upon the upward oblique wall and a secondary section extending from the primary section; wherein
only a distal end of the secondary section abuts against the downward oblique wall.

16. The electrical connector as claimed in claim 15, wherein said primary section is longer than the secondary section.

17. The electrical connector as claimed in claim 15, wherein said secondary section extends downwardly from the primary section.

18. An electrical connector comprising:
an insulative housing defining at least one oblique passageway;
said oblique passageway defining an upward oblique wall and a downward oblique wall under a condition that the downward oblique wall is steeper than the upward oblique wall; and
a contact being disposed in the passageway and defining a long section abutting against one of the upward oblique wall and the downward oblique wall, and a short section extending from the long section; wherein
only a distal end of the short section abuts against the other of said upward oblique wall and said downward oblique wall.

19. The electrical connector as claimed in claim 18, wherein said long section abuts against the upward oblique wall, and the short abuts against the downward oblique wall.
